(19) United States
(12) Patent Application Publication
(10) Pub. No.: US 2025/0188281 A1
(43) Pub. Date: Jun. 12, 2025

(54) RUBBER VOICE DIAPHRAGM, ACOUSTIC GENERATOR AND APPLICATION THEREOF

(71) Applicant: AAC Microtech (Changzhou) Co., Ltd., Changzhou (CN)

(72) Inventors: Yuanwei Su, Changzhou (CN); Hongyuan Wang, Changzhou (CN); Hezhi Wang, Changzhou (CN); Chao Wang, Changzhou (CN)

(21) Appl. No.: 18/669,571

(22) Filed: May 21, 2024

Related U.S. Application Data
(63) Continuation of application No. PCT/CN2023/136630, filed on Dec. 6, 2023.

(51) Int. Cl. C08L 83/04; C08G 77/38; H04R 7/02

(52) U.S. Cl. CPC C08L 83/04; C08G 77/38; H04R 7/02; C08L 2205/025; H04R 2307/025

(57) ABSTRACT

A rubber voice diaphragm including a distortion improving agent with a mass percentage of 1% to 40%. The distortion improving agent is macromolecule polymer with a —Si—O— structure in a main chain, and includes side group and/or side chain. A number-average molecular weight of the side chain of the distortion improving agent is 60 to 20000. An end group and the side group of the distortion improving agent each include at least one of methyl group, ethyl group, propyl group, butyl group, phenyl group, naphthyl group, hydroxyl group, amino group, ester group, and amide group. At least one of the end group, the side group, and the side chain of the distortion improving agent has specific chemical crosslinking points with mass percentage of 0.03% to 30%. The distortion improving agent can significantly improve distortion performance and demolding performance of the rubber voice diaphragm without sacrificing physical performance advantages.

### TECHNICAL FIELD

The present disclosure relates to the field of new materials and, in particular, to a rubber voice diaphragm, an acoustic generator and an application thereof.

### BACKGROUND

Rubber voice diaphragms are favored in the field of high-end acoustic generator due to their unique physical properties. With the increasing demand for sound quality, the requirements for acoustic devices are becoming more and more strict, especially for high and low temperature resistance, waterproof, and other performance. Silicone rubber and fluorosilicone rubber have excellent properties such as high and low temperature resistance and waterproof, which have attracted widespread attention from acoustic researchers. However, silicone rubber and fluorosilicone rubber have the problem of poor damping. When the silicone rubber and fluorosilicone rubber are directly applied to the voice diaphragm of speaker, it will inevitably lead to significant distortion of the voice diaphragm of speaker, and thus their application in the field of voice diaphragm is severely limited.

Many researchers have conducted extensive research on the issue of poor damping of silicone rubber and fluorosilicone rubber. First, there are some problems such as limited effect improvement and poor heat resistance in improving the damping of rubber by packing material or adding micromolecule damping agent. Second, when using rubber to improve damping, in view of the compatibility issues, if the amount of other rubber added is small, the effect is not significant, and if the amount is large, the performance of silicone rubber or fluorosilicone rubber will be undesirably degraded. In addition, some researchers have improved damping by adding the copolymer, as damping agent, of organic silicon and non-silicon materials, but there is still a problem of performance degradation caused by the addition of a large amount of the copolymer, especially in terms of mechanical properties and heat resistance.

Therefore, there is an urgent need in this field for a rubber voice diaphragm that can improve the damping of rubber without reducing other performance thereof.

### SUMMARY

In order to solve the above technical problems, on the one hand, the present disclosure provides a rubber voice diaphragm including a distortion improving agent with a mass percentage of 1% to 40%. The distortion improving agent is a macromolecule polymer with a —Si—O— structure in a main chain, and includes a side group and/or a side chain. A number-average molecular weight of the side chain of the distortion improving agent is 60 to 20000. An end group and the side group of the distortion improving agent each comprise at least one of methyl group, ethyl group, propyl group, butyl group, phenyl group, naphthyl group, hydroxyl group, amino group, ester group, and amide group. At least one of the end group, the side group and the side chain of the distortion improving agent has specific chemical crosslinking points with a mass percentage of 0.03% to 30%.

As an improvement, the specific chemical crosslinking points comprise at least one of silicon hydrogen bond, silicon chloride bond, hydroxyl group, carboxyl group, isocyanate group, acyl chloride, amino group, double bond, triple bond, and epoxy group.

As an improvement, a number-average molecular weight of the distortion improving agent is 1000 to 1000000.

As an improvement, a method for preparing the distortion improving agent comprises: by mass, adding 100 parts of epoxy polysiloxane and 200 to 400 parts of toluene to a reactor, dissolving the epoxy polysiloxane and the toluene evenly, adding 0.1 to 60 parts of maleic anhydride to react at 70° C. to 80° C. for 12 to 24 hours, and removing a solvent to obtain the distortion improving agent.

As an improvement, the rubber voice diaphragm further includes a main rubber, a reinforcing filler, a vulcanizing agent, and a vulcanizing aid.

As an improvement, the main rubber includes at least one of silicone rubber, fluorosilicone rubber, nitrile rubber, hydrogenated nitrile rubber, butyl rubber, styrene butadiene rubber, natural rubber, neoprene rubber, ethylene-propylene-diene monomer rubber, polybutadiene rubber, acrylate rubber, ethylene acrylate rubber, and chlorosulfonated polyethylene.

The rubber voice diaphragm according to the present disclosure includes a specific distortion improving agent. The distortion improving agent is macromolecule polymer with a —Si—O— structure in a main chain, and includes a side group and/or a side chain. At least one of the end group, the side group, and the side chain of the distortion improving agent has specific chemical crosslinking points, which can regulate the damping performance of the distortion improving agent through the end group, the side group, and the side chain. The main chain with —Si—O— structure ensures that the distortion improving agent retains the same excellent heat resistance as silicone rubber and fluorosilicone rubber, while also ensuring excellent compatibility with the main rubber. The high molecular weight ensures that the distortion improving agent has a certain strength. The specific chemical crosslinking points prevent the distortion improving agent from flowing at high temperatures, such that the distortion improving agent has better heat resistance. In general, the distortion improving agent has a comprehensive effect of the same excellent heat resistance as silicone rubber and fluorosilicone rubber, excellent compatibility, sufficient strength, and the chemical crosslinking points that prevents it from flowing at high temperatures. The distortion improving agent can be widely applied to the rubber voice diaphragm without sacrificing the physical performance advantages of the main rubber, and can significantly improve the distortion performance and demolding performance of the rubber voice diaphragm.

On the other hand, the present disclosure further provides an acoustic generator, which includes the rubber voice diaphragm as described above. In a low-frequency range, the total harmonic distortion (THD) of the acoustic generator is significantly reduced, the sound quality is improved, and frequency response for FO are almost unaffected. The acoustic generator can be applied to fields such as phone, headphone, smartwatch, tablet, laptop, desktop, speaker, television, and car.

### BRIEF DESCRIPTION OF DRAWINGS

FIG. 1 shows THD curves of speakers made of existing rubber voice diaphragm and of a rubber voice diaphragm according to the present disclosure.

### DESCRIPTION OF EMBODIMENTS

The present disclosure is described below in conjunction with the drawings and embodiments.

### Preparation of Distortion Improving Agent

By mass, 100 parts of epoxy polysiloxane and 200 to 400 parts of toluene are added to a reactor, and the epoxy polysiloxane and the toluene are dissolved evenly. Then, 0.1 to 60 parts of maleic anhydride are added to react at 70° C. to 80° C. for 12 to 24 hours, and the solvent is removed to obtain the distortion improving agent.

Taking Momentive silicone compound LSR2759 as an example, 10 parts of distortion improving agent, 3 parts of double 25, and 2 parts of Ti activated carbon (TIAC) are added. The above substances are hot pressed for 1 to 20 minutes using a voice diaphragm pressing machine under the conditions of 190° C. to 200° C. and 0.1 MPa to 0.5 MPa, to obtain the rubber voice diaphragm. The voice diaphragm is assembled into a speaker and its distortion (THD) performance is tested.

The acoustic generator including the rubber voice diaphragm according to the present disclosure can be, but is not limited to, the speaker, receiver, and other acoustic generators. Taking the speaker as an example is not intended to limit the scope of application of the present disclosure. The speaker is made of the rubber voice diaphragm according to the present disclosure, and the THD of the speaker is tested.

The present disclosure is further described through the following embodiments. It should be understand that the specific embodiments described here are for illustration purposes only and are not intended to limit the present disclosure.

### Embodiment 1

### Preparation of Distortion Improving Agent 1

By mass, 100 parts of epoxy polysiloxane and 200 parts of toluene were added to a reactor, and the epoxy polysiloxane and the toluene were dissolved evenly. Then, 5 parts of maleic anhydride were added to react at 80° C. for 18 hours, and the solvent was removed to obtain the distortion improving agent 1.

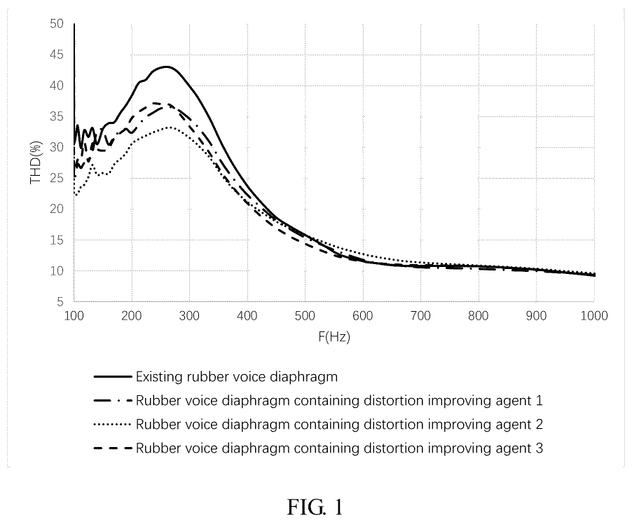

Taking Momentive silicone compound LSR2759 as an example, 10 parts of distortion improving agent 1, 3 parts of double 25, and 2 parts of TIAC were added to prepare the compounded rubber containing the distortion improving agent 1. The compounded rubber was hot pressed for 10 minutes using the voice diaphragm pressing machine under the conditions of 200° C. and 0.2 MPa to obtain the rubber voice diaphragm. The voice diaphragm was assembled into a speaker and its distortion (THD) performance was tested. The results are shown in FIG. 1.

### Embodiment 2

Preparation of Distortion Improving Agent 2

By mass, 100 parts of epoxy polysiloxane and 200 parts of toluene were added to the reactor, and the epoxy polysiloxane and the toluene were dissolved evenly. Then, 8 parts of maleic anhydride were added to react at 80° C. for 24 hours, and the solvent was removed to obtain the distortion improving agent 2.

Taking Momentive silicone compound LSR2759 as an example, 10 parts of distortion improving agent 2, 3 parts of double 25, and 2 parts of TIAC were added to prepare the compounded rubber containing the distortion improving agent 2. The compounded rubber was hot pressed for 10 minutes using the voice diaphragm pressing machine under the conditions of 200° C. and 0.2 MPa to obtain the rubber voice diaphragm. The voice diaphragm was assembled into a speaker and its distortion (THD) performance was tested. The results are shown in FIG. 1.

### Embodiment 3

### Preparation of Distortion Improving Agent 3

By mass, 100 parts of epoxy polysiloxane and 200 parts of toluene were added to a reactor, and the epoxy polysiloxane and the toluene were dissolved evenly. 10 parts of maleic anhydride were added to react at 80° C. for 24 hours, and a solvent was removed to obtain the distortion improving agent 3.

Taking Momentive silicone compound LSR2759 as an example, 10 parts of distortion improving agent 3, 3 parts of double 25, and 2 parts of TIAC were added to prepare the compounded rubber containing the distortion improving agent 3. The compounded rubber was hot pressed for 10 minutes using the voice diaphragm pressing machine under the conditions of 200° C. and 0.2 MPa to obtain the rubber voice diaphragm. The voice diaphragm was assembled into a speaker and its distortion (THD) performance was tested. The results are shown in FIG. 1.

As shown in FIG. 1, it can be seen that the speaker using the rubber voice diaphragm according to the present disclosure can significantly improve the distortion characteristic (THD) of the acoustic generator in the low-frequency range.

In the low-frequency range, the THD of the acoustic generator is significantly reduced, the sound quality is improved, and frequency response for FO are almost unaffected. The acoustic generator can be applied to fields such as phone, headphone, smartwatch, tablet, laptop, desktop, speaker, television, and car.

The above provides a detailed description of some embodiments according to the present disclosure. Those skilled in the art should understand that the above embodiments are for illustration purposes only and are not intended to limit the scope of the present disclosure. Those skilled in the art should understand that any modifications, equivalent substitutions, or improvements made to the above embodiments without departing from the spirit and principles of the present disclosure should fall within the protection scope of the present disclosure.

What is claimed is:

1. A rubber voice diaphragm, comprising a distortion improving agent with a mass percentage of 1% to 40%, wherein the distortion improving agent is a macromolecule polymer with a —Si—O— structure in a main chain, and comprises a side group and/or a side chain, a number-average molecular weight of the side chain of the distortion improving agent is 60 to 20000, an end group and the side group of the distortion improving agent each comprise at least one of methyl group, ethyl group, propyl group, butyl group, phenyl group, naphthyl group, hydroxyl group, amino group, ester group, and amide group, and wherein at least one of the end group, the side group and the side chain of the distortion improving agent has specific chemical crosslinking points with a mass percentage of 0.03% to 30%.

2. The rubber voice diaphragm as described in claim 1, wherein the specific chemical crosslinking points comprise at least one of silicon hydrogen bond, silicon chloride bond, hydroxyl group, carboxyl group, isocyanate group, acyl chloride, amino group, double bond, triple bond, and epoxy group.

3. The rubber voice diaphragm as described in claim 1, wherein a number-average molecular weight of the distortion improving agent is 1000 to 1000000.

4. The rubber voice diaphragm as described in claim 1, wherein a method for preparing the distortion improving agent comprises: by mass, adding 100 parts of epoxy polysiloxane and 200 to 400 parts of toluene to a reactor, dissolving the epoxy polysiloxane and the toluene evenly, adding 0.1 to 60 parts of maleic anhydride to react at 70° C. to 80° C. for 12 to 24 hours, and removing a solvent to obtain the distortion improving agent.

5. The rubber voice diaphragm as described in claim 1, wherein the rubber voice diaphragm further comprises a main rubber, a reinforcing filler, a vulcanizing agent, and a vulcanizing aid.

6. The rubber voice diaphragm as described in claim 5, wherein the main rubber comprises at least one of silicone rubber, fluorosilicone rubber, nitrile rubber, hydrogenated nitrile rubber, butyl rubber, styrene butadiene rubber, natural rubber, neoprene rubber, ethylene-propylene-diene monomer rubber, polybutadiene rubber, acrylate rubber, ethylene acrylate rubber, and chlorosulfonated polyethylene.

7. An acoustic generator, comprising the rubber voice diaphragm as described in claim 1.

8. A product using the acoustic generator as described in claim 7, wherein the product comprises one of phone, headphone, smartwatch, tablet, laptop, desktop, speaker, television, and car.
